(19) United States
(12) Patent Application Publication
(10) Pub. No.: US 2011/0154971 A1
(43) Pub. Date: Jun. 30, 2011

(54) Apparatus for Cutting Reinforced Hose with Reduced Interior Hose Contamination

(75) Inventor: Douglas Serrurier, Morton, IL (US)

(73) Assignee: CATERPILLAR, INC., Peoria, IL (US)

(21) Appl. No.: 12/947,021

(22) Filed: Nov. 16, 2010

Related U.S. Application Data
(60) Provisional application No. 61/290,406, filed on Dec. 28, 2009.

(51) Int. Cl. B26D 3/16; F16L 11/08; B26D 11/00

(52) U.S. Cl. 83/862; 83/168; 138/138

(57) ABSTRACT

A device for cutting reinforced hose to length with limited contamination gaining access to the interior of the hose is disclosed. The device may employ a first rotating blade to circumferentially cut through an outer cover of the hose without penetrating through an interior liner of the hose. The outer cover may be composed of an elastomeric cover reinforced with metallic strands. By preventing the first blade from penetrating the interior liner, the contamination from the kerf created by the blade is not able to access the interior of the hose. After the first blade performs its partial cut around the outer circumference of the hose, the hose may be cleaned and a second blade may be used to cut through the interior liner. The second blade results in very little contamination and thus a cut length of hydraulic hose is created with greatly reduced levels of contamination within the hose without needing a post-cutting cleaning operation.

### CROSS-REFERENCE TO RELATED APPLICATION

This is a non-provisional US patent application claiming priority under 35 USC §119 (e) to U.S. Provisional Application No. 61/290,406, filed on Dec. 28, 2009.

### TECHNICAL FIELD

The present disclosure generally relates to reinforced hoses and, more particularly, relates to apparatus for cutting reinforced hoses.

### BACKGROUND

Reinforced hose is widely used on numerous industrial machines and vehicles. Such hose is typically formed of an elastomer such as rubber reinforced with metal strands or fibers, and may be used for such things as communicating pressurized hydraulic fluid from a pump to cylinders, motors and the like for performing work. The hoses are typically flexible to enable movement of the components being driven by the hydraulic fluid, be they lifts, blades, motors or any other form of device, and yet are reinforced with metal, fibers, or the like as they need to safely communicate high pressure hydraulic fluid and withstand rugged working conditions.

When machines using reinforced hose are manufactured, the reinforced hose is typically cut to the desired length and then may be terminated with suitable couplings or fittings to enable attachment to the machine or tool. In order to cut the hose, the hose is typically passed through a rotating saw blade. While effective, this introduces a fair amount of contamination into the interior of the hose. The contamination is mostly particles of elastomer and reinforcement created by the blade passing through the hose. More specifically, the contamination from the kerf created by the blade may be small dimension pieces of rubber and metal which must be cleaned out of the hose before the hose can be used. For example, the contamination may be large enough to detect with the naked eye (about 40 microns or larger), or be microscopic in size (less than 40 microns). If not adequately cleaned, such contaminates can damage the hydraulic pumps, valves, and other moving parts of the hydraulic system, or other fluid systems. Alternatively, they may result in hydraulic cylinder drift, erratic steering, unreliable operation, slower performance, or expensive downtime, among others. This in turn can reduce the life of a product if not properly cleaned out prior to installation on a machine.

In order to clean the hose, manufacturers typically attach an end of the cut hose to a source of pressurized air, solvent or other fluid for a set duration. After the fluid is directed though the hose in a first direction, the hose is then reversed and the other end of the hose is connected to the source of pressurized fluid. In addition to, or as an alternative to, the pressurized fluid, foam or otherwise elastomeric projectiles can be launched (with air) or pulled through the hose to clean same. With either approach a significant amount of time is invested cleaning the cut hose prior to it being usable. In fact, ISO (International Organization for Standardization) standards dictate that such hoses and the fluids they carry must have less than a set number of particles of certain sizes per unit of volume in order to be satisfactory.

Not only do cutting methods introduce an inordinately high amount of contamination into the hose, but due to the hoses being formed largely from rubber and metal, they are prone to static electricity build-up during handling. As a result, when the cut is made and the contamination is created, the particles tend to cling to the inside of the hose making the process of cleaning that much more difficult. Depending on the time of year and manufacturing conditions, the humidity level of the ambient environment can also contribute to the particles adhering to the inside of the hose as well.

Once manufactured, and the machines are placed in use, the hydraulic hoses are subject to wear and damage. Accordingly, the hoses need to be periodically replaced. The local repair facility therefore has to undertake the same cutting and post-cutting cleaning operation as that performed by the manufacturer, again adding to the cost of the process. Another cost of maintenance is that the hydraulic systems on such machines often employ filters designed to remove particulates from the hydraulic fluid. Such filters need to replaced periodically, typically after the first 50 hours of use (longer durations after the initial change), again adding to the cost of operation, especially if the cleaning process for the hoses is not done adequately. Even if cleaned to meet current standards, the contamination created by current cutting processes often creates particulates of such a small dimension that the filters are not able to remove all of them and which over time can contribute to clogging of valves or other moving parts within the hydraulic system.

### SUMMARY OF THE DISCLOSURE

In accordance with one aspect of the disclosure, a device for cutting reinforced hose to length is disclosed, which includes a first blade for cutting through an outer layer of the hose down to a predetermined depth and leaving an interior liner of the hose intact, a cleaning tool for cleaning the hose, and a second blade for cutting through the interior liner.

In accordance with another aspect of the disclosure, a reinforced hose having an interior liner surrounded by an elastomeric cover reinforced with metal strands is disclosed wherein the hose is manufactured by a method comprising holding a length of hose relative to a rotating first blade, circumnavigating the rotating first blade around the hose while plunging the rotating blade radially inward to pass through the elastomeric cover and metal strands, stopping and radially retracting the rotating blade when the rotating blade reaches the interior liner; cleaning the hose; and cutting through the interior liner with a second blade.

In accordance with a further aspect of the disclosure, a device for cutting reinforced hose to length is disclosed, wherein the machine produces a length of hose having an ISO Standard 3862 particle count of 18:15 without employing a post-cutting cleaning step.

### BRIEF DESCRIPTION OF THE DRAWINGS

FIG. 1 is a schematic representation of a machine constructed in accordance with the teachings of the disclosure;

FIG. 2 is a cross sectional view of the hose depicted in FIG. 1, taken along line 2-2 of FIG. 1;

FIG. 3 is schematic representation of the first station of the machine of FIG. 1 while the first and third blades are in use;

FIG. 4 is an cross-sectional view of the first station depicted in FIG. 3 taken along line 4-4 of FIG. 3;

FIG. 5 is schematic representation of the first station of the machine of FIG. 1, after the first and third blades have been retracted;

FIG. 6 is a schematic representation of the second station of the machine of FIG. 1, after the second blade has sheared the interior liner of the hose; and

FIG. 7 is a flowchart depicting a sample sequence of steps which may be practiced in accordance with the teachings of this disclosure.

### DETAILED DESCRIPTION

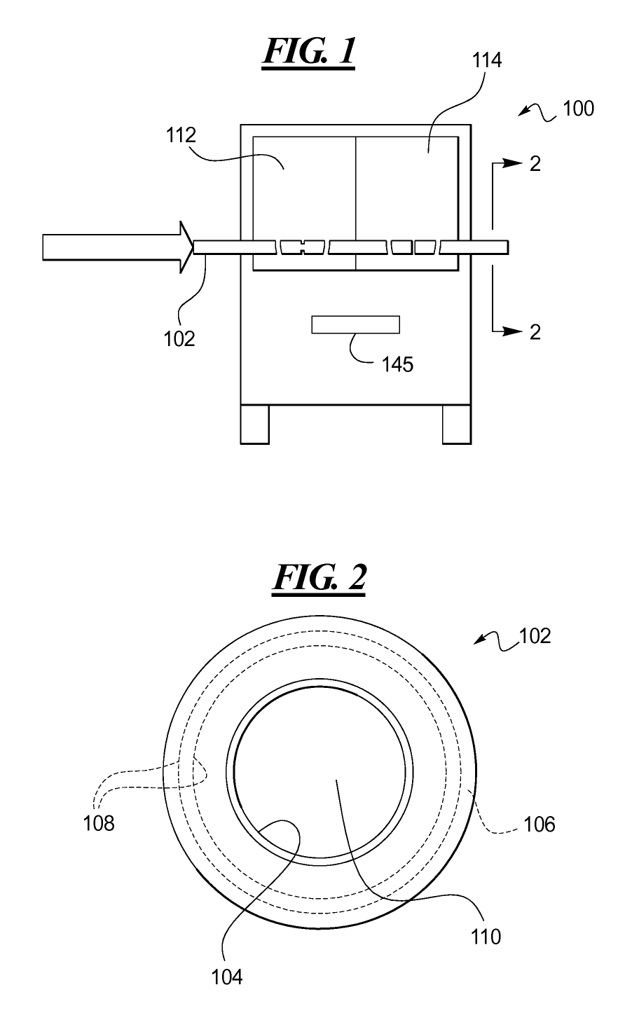

Referring now to the drawings, and with specific reference to FIG. 1, a device for cutting reinforced hose to length and constructed in accordance with the present disclosure is generally referred to by reference numeral. With reference to FIG. 2, the reinforced hose may include a liner around which is provided an elastomeric cover. Both the liner and cover are sufficiently flexible to enable the hose to be used in myriad industrial applications. For example, such hose could be used to connect a hydraulic pump to a hydraulic cylinder provided on a construction or maintenance vehicle. The elastomeric cover may be reinforced with metallic wire or strands. While FIG. 2 depicts two layers of reinforcing metallic strands, it is to be understood that this is exemplary only, more or less layers of reinforcement and elastomer could be provided. The reinforcement may also be provided with materials other than metal. The reinforcement provide the hose with strength sufficient to contain the highly pressurized fluid, such as hydraulic fluid for example. It also enables the hose to withstand the rugged working environments such hoses often confront.

However, with conventional cutting machines and processes, a rotating saw is typically pushed through the hose and some of the contamination created by the resulting kerf is introduced into an interior. As mentioned above, this contamination may be comprised of small dimension particles of rubber and metal which can clog valves, plug cylinders and otherwise interfere with the proper operation of any moving part of a hydraulic or other fluid system to which the hose is eventually connected.

With the present disclosure, on the other hand, the device enables the hose to be cut with greatly reduced contamination reaching the interior of the hose. Starting again with FIG. 1, one embodiment of the device may include a first cutting station and a second cutting station. The first cutting station may be used to cut through the elastomer and reinforcement of the cover and wire strands without penetrating the liner, while the second cutting station may be used to cut through the liner after the first cutting station has completed its cut and the hose has been cleaned as will be explained in greater detail below.

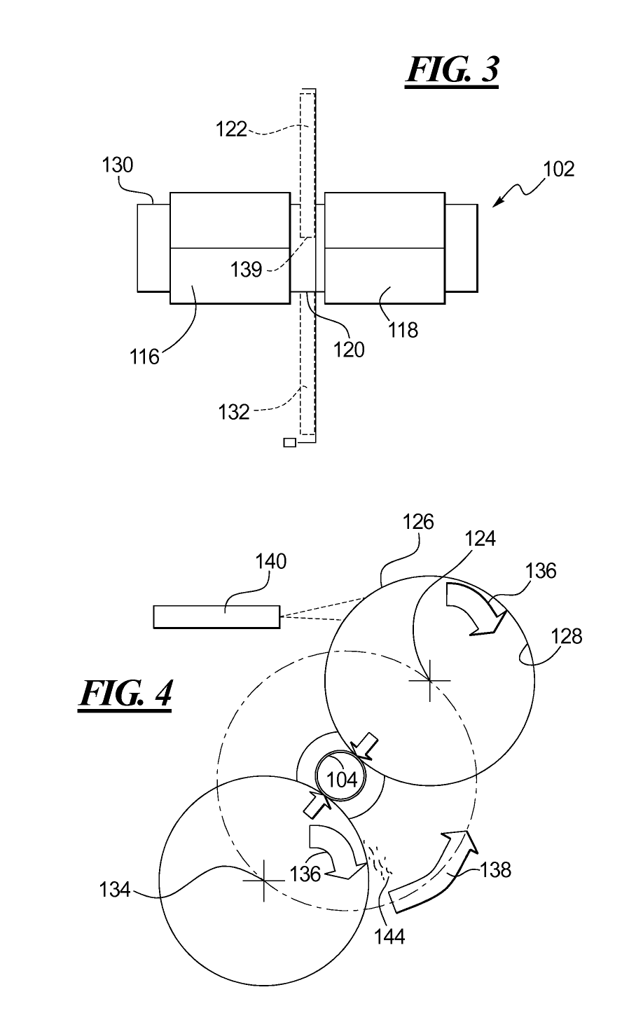

The first cutting station is shown more extensively in FIGS. 3 and 4. Starting with FIG. 3, the hose may be secured to the first cutting station by way of first and second clamps. The clamps and may be clamshell in design, and be mechanically or hydraulically openable and closable. Of course other forms of clamps or devices for stabilizing the hose while cutting will be readily understood by those of ordinary skill in the art.

The clamps may laterally flank an area of the hose to be cut. Accordingly, a first blade may extend from the device between the clamps and be aligned with area. As shown best in FIG. 4, the first blade may rotate about its axis while at the same time rotate or circumnavigate around the hose. While the blade so rotates it may radially plunge into contact with the hose to cut same. More specifically, a cutting surface provided at the circumference of the first blade may first engage an outer circumference of the cover. The cutting surface may be provided in sufficiently abrasive form so as to cut through the cover, or a series of teeth or the like may be provided in known fashion.

Working in concert with the first blade, another rotating blade referred to herein as the third blade, may optionally be employed. The rotating blade may be identical to first blade, but simply be provided 180° apart from the first blade relative to the hose. Similarly, the blade may rotate about its axis in direction and also rotate around the circumference of the hose in the same direction as the first blade. In so doing, the device, specifically the first station of the device, can more quickly perform its task and thus increase throughput passed through the device. In addition, the use of the third blade positioned in such a fashion relative to the first blade balances the load imparted on the hose and thereby helps to avoid physical deformation of the hose. As the hose is likely to be installed to carry a fluid in sealed fashion, maintaining the cross-section shape of that hose helps to maintain that seal.

As also shown in FIG. 4, the first blade (and third blade if used) do not penetrate entirely through the hose. Rather, they penetrate only though the cover and reinforcement strands and stop at a predetermined depth, for example, once they remove a majority of the hose material and leave a thin layer of liner. Such motion may be monitored by any number of different sensing and closed loop feedback systems. For example, a laser sensor may be used wherein once the blade breaks the plane of the laser, the blade will stop radially plunging into the hose and retract. Alternatively, an open loop system can be employed wherein a sensor is not used, but rather the blades simply plunged radially inward a predetermined amount based on the diameter of the hose and relative thicknesses of cover and liner.

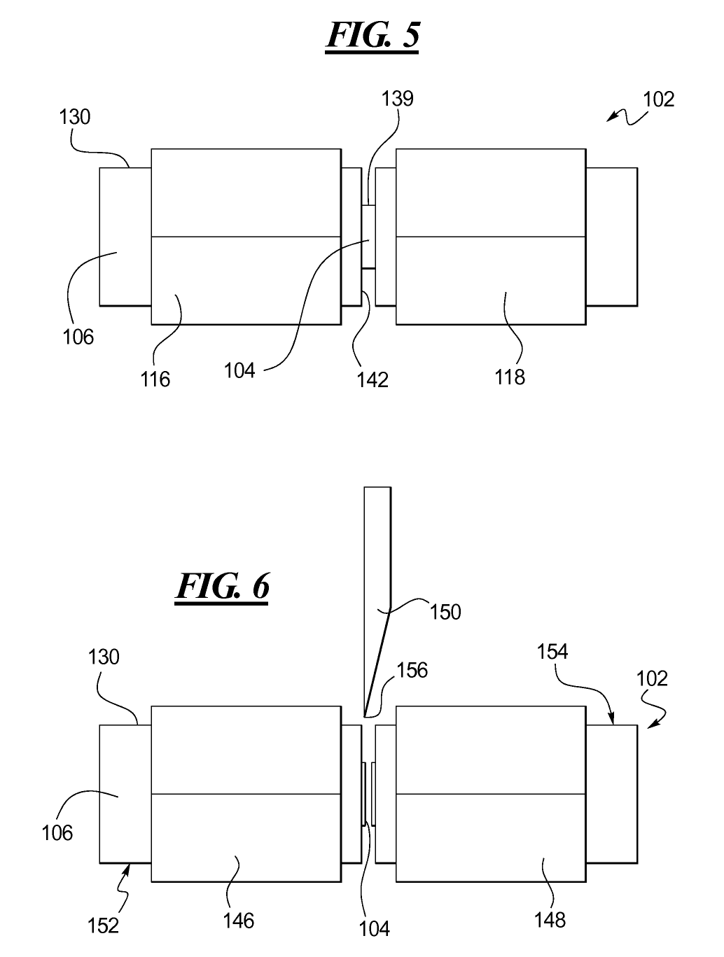

After the blade is retracted, as shown in FIG. 5, a kerf will be revealed in the cover where the blade has removed material during its cutting operation. That removed material, also referred to as contamination, may be formed of small dimension particles of the elastomer and reinforcement forming the hose. For example, such particles are commonly on the order of five to three hundred microns in size or the like. However, by preventing the blade from penetrating the liner the debris cannot enter the interior of the hose.

After the kerf is created the hose may be cleaned to remove any contamination clinging to the kerf or other parts of the hose. Such cleaning may be performed with a cleaning tool such as a source of compressed air or other fluid, a bath into which the hose can be submerged, a washing instrument, a vacuum or the like. By cleaning the hose after the first cutting station is complete, the likelihood of any contamination reaching the interior of the hose when the second cutting station severs the liner is greatly reduced.

Once the first cutting station has performed its task and the hose has been cleaned, the hose can be moved within the clamps so as to align the kerf with the second cutting station. The second cutting station may include its own set of clamps to secure the hose as needed. Alternatively, the hose can stay stationary and the first and second cutting stations can move relative to the hose. In a still further alternative, a single station or single blade can be provided and be programmed and manufactured to perform the functions of both stations and all blades.

Referring now to FIG. 6, the second cutting station is shown in greater detail to include a razor, shearing or rotating blade. As used herein, the blade is referred to as the second blade. In a first embodiment, the second blade may rotate around the liner, scoring the circumference of the liner and slicing through the liner. By using a sharply edged blade such as a razor, not only is little contamination generated, but deformation of the cross-section shape of the liner is avoided as well.

In an alternative embodiment, the second blade may be mounted so as to move through the liner in guillotine fashion. More specifically, the second blade may be adapted to traverse laterally through or across the liner and in so doing shear leading hose section from trailing hose section. Such motion may be accomplished in any number of different ways including the mounting of the blade on rails (not shown) laterally flanking the hose, or driving the blade with a linear actuator, solenoid actuated spring, motor, or the like.

By shearing the leading section from the trailing section, little to no contamination is generated. The sharp apex of the blade simply penetrates the liner with sufficient speed and power to cleave the hose apart. Moreover, as a large majority of the material composing the hose has already been removed by the rotating first blade, even if the shearing blade generates some debris, it is relatively minimal. For example, the inventors have found the first blade can remove up to 95% or more of the material of the hose, thereby leaving little material to generate debris.

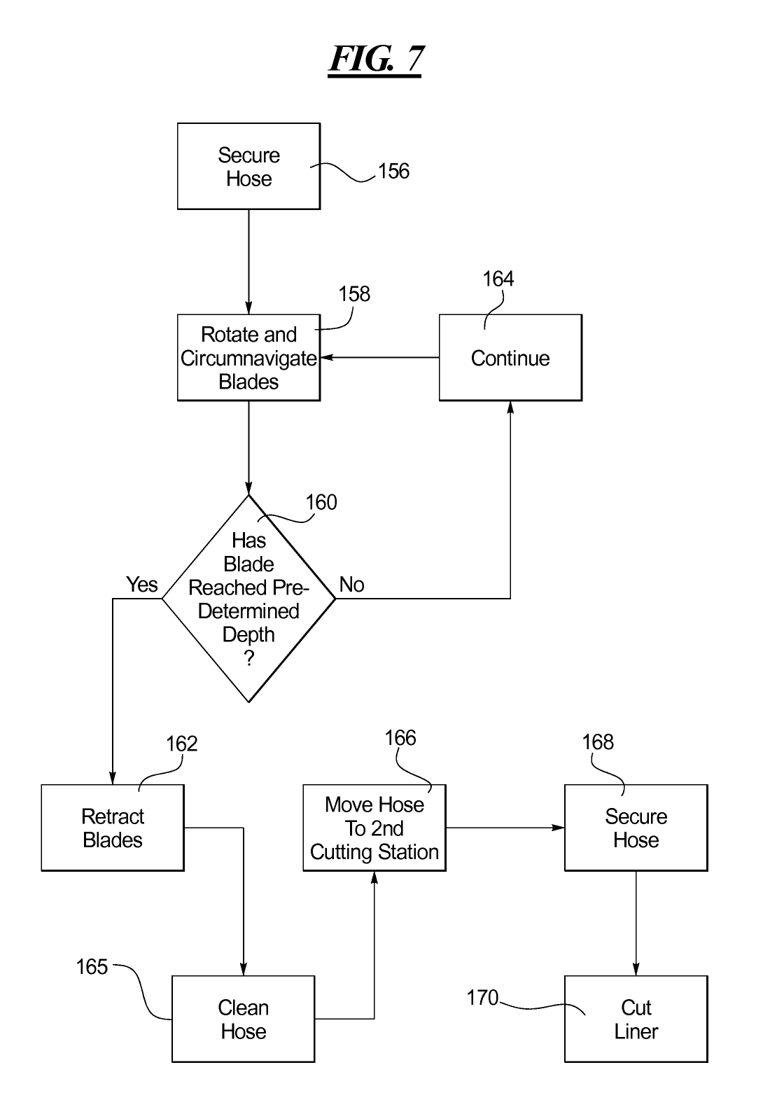

In summary, FIG. 7 provides a sample sequence of steps which may be practiced according to the teachings of this disclosure. Starting with a step, the hose can be secured into the device with clamps. The blade(s) of the first cutting station can then be rotated about their axes with both circumnavigating the hose as shown by a step. While the blades are both rotating and circumnavigating, the sensor may monitor the depth to which the blades are plunging through the cover as shown in a step. If the blades have reached a predetermined depth, the blades can stop and radially retract away from the hose as shown by a step. If the blades have not yet reached their predetermined depth, the blades may continue as indicated by a step.

Once the kerf has reached its predetermined depth, the hose can then be cleaned in a step. As mentioned above, this may be done using a cleaning tool employing compressed air or fluid, submerging the hose in a cleaning fluid, washing the hose, vacuuming the hose, or the like. In so doing, any contamination clinging to the hose or kerf is removed and thus cannot access the interior of the hose.

Once the hose has been cleaned, the hose can be moved to the second cutting station as shown in a step. At second cutting station, the hose is secured in a step by clamps, with the kerf aligned with the second blade. The second blade then cuts through the liner in a step to result in trailing hose section and leading hose section with little to no debris being introduced into the interior of the hose.

In order to quantify the reduction in debris introduced into the hose, reference to ISO Standard 3862:2009 is helpful. That standard dictates the conditions to which rubber-cover spiral-wire reinforced hose must be manufactured. To do so, the standard quantifies the resulting hose, and fluid it carries, in terms of the number of particles therein per milliliter of fluid. For example, a hose having an ISO rating of A:B would mean that the hose has a number of particles corresponding to the A rating which are greater than or equal to 5 microns per milliliter, and a number of particles corresponding to the B rating which are greater than or equal to 15 microns. In this regard, the following ISO chart is helpful:

| ISO Code | Particles per ML |
|---|---|
| 23 | 40,000-80,000 |
| 22 | 20,000-40,000 |
| 21 | 10,000-20,000 |
| 20 | 5,000-10,000 |
| 19 | 2,500-5,000 |
| 18 | 1,300-2,500 |
| 17 | 640-1,300 |
| 16 | 320-640 |
| 15 | 160-320 |
| 14 | 80-160 |
| 13 | 40-80 |
| 12 | 20-40 |
| 11 | 10-20 |

A common standard heavy equipment manufacturers have to meet with their reinforced hose in this regard is an ISO rating of 18:15. Using the chart above, this means that the hose or fluid it carries must have no more than 1,300-2,500 particles per milliliter which are greater than or equal to 5 microns in size, and no more than 160-320 particles which are greater than or equal to 15 microns in size. Anything higher than that requires a new hose to be used, or the tested hose to be extensively cleaned. As indicated above, the prior art has had to reach this level through a time-intensive and laborious post-cutting cleaning process. However, not only is the present disclosure able to meet that standard, but greatly exceed it without any post-cutting cleaning being required. More specifically, the inventors have been able to cut hose with ratings of as low as 18:15, or 16:13, or even 14:11, without employing any form of cleaning operation. As the above ISO scale is not linear, it can be seen that this translates into a more than 95% reduction in the amount of contamination introduced into the hose. Accordingly, hose of higher standards can be manufactured in less time and lower cost. In addition, once installed such hose can operate longer, filters can be used at greater replacement intervals, and the moving parts of the hydraulic or other fluid system can have a longer serviceable life with less down time and fewer warranty claims back to the manufacturer.

### INDUSTRIAL APPLICABILITY

From the foregoing, it can be seen that the technology disclosed herein has industrial applicability in a variety of settings such as, but not limited to, cutting reinforced hose. Such hose can in turn be used, for example, on various machines such as, but not limited to, track-type tractors, loaders, excavators, pipelayers, and graders, to carry hydraulic fluid and the like. Since the hose can be cut to a desired length with greatly reduced contamination being introduced into the hose, previously required post-cutting cleaning techniques are no longer necessary. Moreover, the device disclosed herein can be used not only in the original manufacturing facility, but in off-site repair facilities or even mounted on mobile units such as repair trucks or the like to quickly and accurate cut hose to length with higher quality.

What is claimed is:

1. A device for cutting reinforced hose to length, comprising:
a first blade for cutting through a cover of the hose down to a predetermined depth and leaving an interior liner of the hose intact;
a cleaning tool for cleaning the hose after the first blade has made a cut; and
a second blade for cutting through the interior liner.

2. The device of claim 1, further including clamps adapted to hold the hose, the first and second blades passing between the clamps.

3. The device of claim 2, wherein the first blade and second blade are provided at first and second work stations on the device.

4. The device of claim 1, wherein the first blade is a rotating blade.

5. The device of claim 4, wherein the first blade circumnavigates the hose as the first blade rotates.

6. The device of claim 5, wherein a third blade works in concert with the first blade.

7. The device of claim 6, wherein the third blade is positioned 180° apart from the first blade relative to the hose as the first and third blades circumnavigate the hose.

8. The device of claim 1, wherein the second blade circumnavigates and slices through the hose.

9. The device of claim 1, further including a sensor adapted to monitor the predetermined depth.

10. The device of claim 9, wherein the sensor employs a laser.

11. A reinforced hose having an interior liner surrounded by an elastomeric cover reinforced with metallic strands, the hose manufactured by a method comprising:
holding a length of hose relative to a rotating first blade;
circumnavigating the rotating first blade around the hose while plunging the rotating blade radially inward to pass through the elastomeric cover and metallic strands;
stopping and radially retracting the rotating blade when the rotating blade reaches the interior liner;
cleaning the hose; and
cutting through the interior liner with a second blade.

12. The reinforced hose of claim 11, wherein the hose is held in place by clamps provided on a device for cutting the hose.

13. The reinforced hose of claim 12, wherein the first and second blades are also provided on the device.

14. The reinforced hose of claim 11, further including providing a third blade, the third blade being a rotatable blade, the third blade working in concert with the first blade to saw through the elastomeric cover and metallic strands.

15. The reinforced hose of claim 14, wherein the third blade is positioned 180° apart from the first blade relative to the hose as the first and third blades circumnavigate the hose.

16. A device for cutting reinforced hose to length, the device producing a cut length of hose having an ISO Standard 3862:2009 particle count of 18:15 without employing a post-cutting cleaning step.

17. The device of claim 16, wherein the produced hose has an ISO Standard 3862:2009 particle count of 16:13 without employing a post-cutting cleaning step.

18. The device of claim 16, wherein the produced hose has an ISO Standard 3862:2009 particle count of 14:11 without employing a post-cutting cleaning step.

19. The device of claim 16, further including a first blade for cutting through an elastomeric cover reinforced with metal strands down to a liner, and a second blade for cutting through the interior liner.

20. The device of claim 19, further including a third blade, the first and third blades adapted to circumnavigate the hose while radially plunging through the elastomeric cover reinforced with metallic strands, but not penetrating the interior liner.
